(19) United States
(12) Patent Application Publication
(10) Pub. No.: US 2020/0341763 A1
(43) Pub. Date: Oct. 29, 2020

(54) SECURE ELEMENT WITH PERSONALIZABLE FUNCTIONS AND CORRESPONDING MANAGEMENT METHOD

(71) Applicant: STMicroelectronics (Rousset) SAS, Rousset (FR)

(72) Inventors: Laurent TABARIES, Aubagne (FR); Jean-Luc BLANC, Pourrieres (FR); Yveline GUILLOUX, Gardanne (FR)

(73) Assignee: STMicroelectronics (Rousset) SAS, Rousset (FR)

(21) Appl. No.: 16/738,057

(22) Filed: Jan. 9, 2020

(30) Foreign Application Priority Data
Jan. 8, 2019 (FR) 1900143

(51) Int. Cl. G06F 9/30; G06F 3/06

(52) U.S. Cl. CPC G06F 9/30029; G06F 3/0679; B60W 2050/0026; G06F 3/0604; G06F 3/0659

(57) ABSTRACT

A secure element includes a non-volatile memory. The non-volatile memory stores first instructions relating to pre-established security functions and at least one second instruction relating to at least one other personalized function. A processing unit executes at least one instruction from amongst the first instructions and the at least one second instruction obtained from the non-volatile memory.

### PRIORITY CLAIM

This application claims the priority benefit of French Application for Patent No. 1900143, filed on Jan. 8, 2019, the content of which is hereby incorporated by reference in its entirety to the maximum extent allowable by law.

### TECHNICAL FIELD

Embodiments and their implementations relate to secure elements, in particular those compatible with the standard TCG-TPM 2.0. Such secure elements conforming to the standard TCG-TPM 2.0 are generally denoted under the term “TPM” (“Trusted Platform Module”).

### BACKGROUND

Secure elements are typically integrated circuits whose function is to perform critical tasks in electronic and data processing systems, such as checks upon start-up, or certifying critical requests, for example by cryptographic processes.

The secure elements are typically made secure from a software point of view via encryptions using proprietary keys, and from a hardware standpoint via anti-fraud devices.

The standard TCG-TPM 2.0 has been established by the TCG (for “Trusted Computing Group”) consortium for standardizing the techniques dedicated to rendering a system secure, notably by integration of encryption keys into the hardware, denoted by the acronym TPM (for “Trusted Platform Module”). Version 2.0 of this standard has been published in March 2014.

The TPM standard (TPM2.0) describes a finite set of commands and of pre-defined functions allowing numerous security functions to be carried out, in accordance with communications protocols such as the SPI (for “Serial Peripheral Interface”) protocol.

Secure elements of the TPM type are conventionally used in computers and servers as a trustworthy source, for example for verifying the integrity of the computer during the initialization of the system.

Today, mobile telephone and touchscreen tablet systems, together with the electronic systems of the automobile industry, are increasingly concerned by the need to be made secure.

Indeed, in particular, the electronic systems of the automobile industry and increasing number of electronic control units each comprise, for example, a microcontroller and a memory for executing applications, and form a complex system of separate networks. Furthermore, the electronic systems of the automobile industry are almost all connected to the Internet and to local personal networks.

It is therefore desirable, in this context, to benefit from the protection devices provided by secure elements of the TPM type.

Furthermore, the electronic systems of the automobile industry in particular have specific constraints typically much more demanding than in other fields.

However, although the list of commands and functions of the TPM standard is long, it would be desirable to have access to undefined specific functions, or to allow personalized instructions to be added.

### SUMMARY

Embodiments and implementations are aimed at a secure element providing personalized instructions and functions, in addition to those provided for example by the standard TCG-TPM 2.0, in order to widen the potential for action of the secure element and provide a flexible solution fully complying with the requirements of the TPM standard for example.

According to a first aspect, a method is provided for managing the operation of a secure element comprising a loading into a non-volatile memory of this secure element of first instructions relating to pre-established security functions and of at least one second instruction relating to at least one other personalized function, and at least one execution of one instruction from amongst the first instructions and the at least one second instruction.

Thus, in contrast, for example, to a hard coded execution of a secure element, the method according to this aspect benefits notably by the use of a loading into a non-volatile memory, for example a Flash memory, and from a flexibility while at the same time providing a set of pre-established security functions.

A personalized function is, for example, a function established by a user of the secure element, for example an automobile manufacturer, who plans to equip certain vehicles of its make with such secure elements with the possibility of personalizing these secure elements with one or more personalized functions dedicated, for example, to certain requirements of this manufacturer.

According to one embodiment, the method comprises a receipt of an operational code, a conversion on the fly of the received operational code into a corresponding instruction belonging to the first instructions or to the at least one second instruction, and the execution of the corresponding instruction.

This embodiment notably allows very demanding constraints with regard to speed to be met.

Advantageously, the method comprises, at each start-up of the secure element, loading of the first instructions and of the at least one second instruction from the non-volatile memory to a conversion table, and assigning to the first instructions and to the at least one second instruction a respective reference operational code. The conversion also comprises a comparison of the operational code received with the reference operational codes so as to identify the corresponding instruction to be executed.

Thus, any type of personalized function may be adapted to the secure element, via the loading from the non-volatile memory to the conversion table, without however having to adapt the mechanism of the secure element nor modifying its design.

For example, the received operational code comprises binary data, and the comparison comprises exclusive NOR logical operations for identifying, on the fly, the reference operational code corresponding to the received operational code. The exclusive NOR logical operations are, of course, carried out between the binary data of the received operational code and binary data of the operational codes assigned to the instructions.

This embodiment notably allows very demanding constraints with regard to speed to be satisfied, the identification taking the time of one logical operation, which is minimal.

The method may comprise the receipt of an input control signal on an input/output interface of the secure element, comprising the received operational code.

According to one embodiment, the loading into the non-volatile memory is only done once during a phase for production of the secure element. For this purpose, a memory area could be reserved for the manufacturer, rendered hardware inaccessible outside of the production phase.

According to one embodiment, the pre-established security functions form part of a library of commands and of functionalities of the standard “TCG-TPM 2.0”.

According to one embodiment, the at least one other personalized function comprises a function which is not provided by the pre-established security functions, or a complementary function improving or personalizing the execution of one of the pre-established security functions.

According to one embodiment, the method further comprises the generation of at least one control signal designed to control the at least one execution.

The method is advantageously intended to be applied to a vehicle of the automobile type, and the generation of at least one control signal comes from at least one of the following electronic control units, incorporated into the vehicle: a telematic control unit, an inter-network gateway unit, a driving assistance unit.

According to another aspect, a secure element is provided, comprising a non-volatile memory configured for storing first instructions relating to pre-established security functions and for storing at least one second instruction relating to at least one other personalized function, and a processing unit configured for executing at least one instruction from amongst the first instructions and the at least one second instruction.

According to one embodiment, the secure element is capable of receiving an operational code, and comprises a conversion table configured for converting, on the fly, a received operational code into a corresponding instruction belonging to the first instructions or to the at least one second instruction, the processing unit being configured for executing the corresponding instruction.

Advantageously, the secure element is configured for, at each start-up of the secure element, loading the first instructions and the at least one second instruction from the non-volatile memory, and assigning to the first instructions and to the at least one second instruction a respective reference operational code. The conversion table is also configured for comparing the received operational code with the reference operational codes so as to identify the corresponding instruction to be executed.

For example, the received operational code comprises binary data, and the conversion table comprises exclusive NOR logic gates for identifying, on the fly, the reference operational code corresponding to the received operational code.

For example, the secure element comprises an input/output interface designed to be connected with an electronic control unit, and to receive an input control signal on the input/output interface comprising the received operational code.

According to one embodiment, the non-volatile memory is configured so as to be written only once during a phase for production of the secure element.

According to one embodiment, the pre-established security functions form part of a library of commands and of functionalities of the standard “TCG-TPM 2.0”.

According to one embodiment, the at least one other personalized function comprises a function which is not provided by the pre-established security functions, or a complementary function improving or personalizing the execution of one of the pre-established security functions.

A system is also provided comprising at least one secure element such as defined hereinbefore, together with at least one electronic control unit configured for generating control signals intended to control the execution of the at least one instruction.

A vehicle of the automobile type may advantageously comprise such a system, and the at least one electronic control unit comprises at least one of the following units: a telematic control unit, an inter-network gateway unit, a driving assistance unit.

### BRIEF DESCRIPTION OF THE DRAWINGS

Other advantages and features of the invention will become apparent upon examining the detailed description of embodiments and of their implementation, which are in no way limiting, and from the appended drawings in which:

FIG. 1 illustrates one exemplary embodiment of a secure element;

FIG. 2 illustrates one exemplary embodiment of the secure element allowing a quick execution with limited resources;

FIG. 3 illustrates one exemplary embodiment of a look-up table of a secure element;

FIG. 4 illustrates one example of an integrated circuit incorporating a secure element;

FIG. 5 illustrates one example of an electronic system; and

FIG. 6 illustrates one exemplary implementation of a method, in particular a step for loading instructions into a memory.

### DETAILED DESCRIPTION

FIG. 1 shows one exemplary embodiment of a secure element SEC benefiting from a flexibility in the use of its functions, while at the same time complying with standardized security criteria.

In contrast to conventional secure elements, generally hard coded and hence impossible to personalize, the secure element SEC comprises a non-volatile memory MEM containing instructions relating to the functionalities of the secure element SEC.

The non-volatile memory MEM is thus configured for storing first instructions ins_sec and second instructions ins_pers, or at least one second instruction ins_pers.

The first instructions ins_sec allow pre-established security functions FS to be executed, and the second instructions ins_pers allow other personalized functions FP to be executed.

The other personalized functions FP are established by a user UTL, in other words for example a client intending to use the secure element SEC.

For security reasons, the first instructions and the second instructions are written into a reserved area RSV of the memory MEM, for example an area whose write access is not permitted outside of a phase for production (such as electronic wafer sort EWS) of the security element SEC.

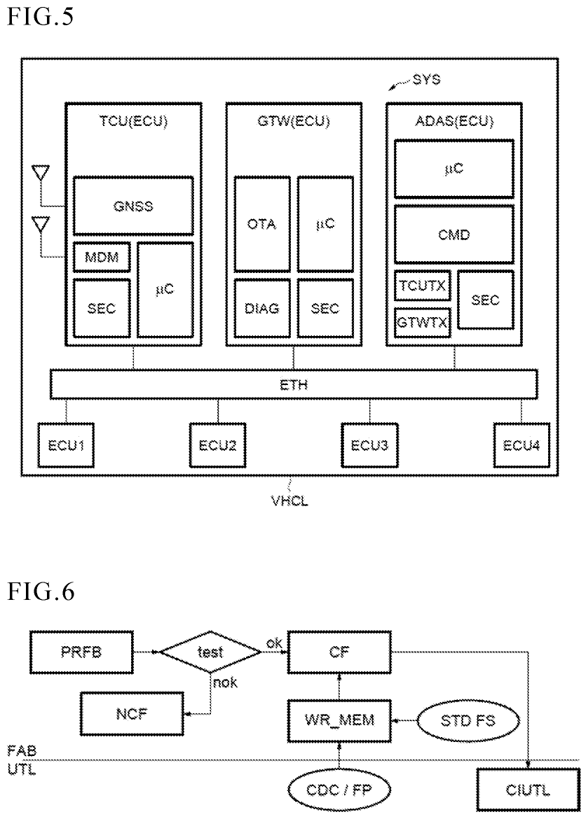

In this regard, reference is made to FIG. 6.

FIG. 6 illustrates one exemplary implementation of a method, in particular a step for loading instructions into the memory MEM.

At the end of a phase PRFB for fabrication of the secure element, in the form of an integrated circuit fabricated on a silicon wafer, a phase for sorting the wafers under electrical characterization EWS is typically implemented. During this phase EWS of the production, an electrical test is carried out and the wafers that conform CF are separated from the non-conforming wafers NCF. At this time, a single write operation WR_MEM is carried out notably into the reserved part RSV of the memory MEM, and potentially into non-volatile read-only memories. This single write operation allows the first instructions for pre-established security functions STDFS, for example according to a standard, to be loaded and the second instructions for the personalized functions CDC/FP to be loaded.

The end user UTL may, for example, supply the source code of the second instructions FP to the manufacturer FAB of the secure element. The end user UTL may also supply a specification CDC comprising criteria defining the at least one personalized function FP, the manufacturer FAB then being responsible for designing the source code for the second instructions FB according to the specifications CDC.

The non-volatile memory MEM is thus advantageously configured for writing WR_MEM only once during the fabrication EWS of the secure element SEC.

The end user UTL subsequently benefits from a secure element CIUTL according to their own personalization CDC/FP and potentially conforming to a standard STDFS.

Reference is again made to FIG. 1.

The secure element SEC lastly comprises a processing unit CPU configured for executing the first instructions ins_sec and the second instructions ins_pers.

In particular, the secure element SEC may be of the slave peripheral type, for which the executions of the first instructions ins_sec and of the second instructions ins_pers are controlled by a master peripheral μC, typically comprising a master microcontroller.

For this purpose, the secure element SEC may comprise an input/output interface GPIO designed to be connected with a master peripheral μC.

For example, the master peripheral μC is an electronic control unit for an electronic system of the automobile industry.

The master peripheral μC is configured for generating control signals controlling slave devices, which are thus received on the input/output interface GPIO. A control signal may comprise operational codes opc, typically a series of binary data denoting a given function, which has been pre-established.

For example, the input/output interface GPIO, and the control signals for the master-slave peripherals may correspond to an application of the SPI (for “Serial Peripheral Interface”) protocol (conventional and known per se).

Furthermore, the secure element SEC meets standardized security criteria, such as for example EAL4+, EAL5+ certifications for the hardware, or standards of the TCG-TPM type for the software.

Thus, the pre-established security functions FS may notably be included in a library of commands and of functionalities of the standard “TCG-TPM 2.0”, and may comply with the criteria of this standard.

Furthermore, the at least one other function FP personalized by the user UTL may comprise a function which is not included in a library of functions belonging to a given standard, or at least which is not provided by the pre-established security functions FS loaded into the memory MEM.

The at least one other function FP personalized by the user UTL may also comprise a complementary function for improving or personalizing the execution of one of the pre-established security functions FS.

It will of course be ensured that the personalized functions FP remain in accordance with the requirements of the standards. In this respect, personalized functions FP may, for example, be provided which use the secure mechanisms complying with criteria that are standardized, but in a manner which is not included in a library of commands and of functionalities of a given standard.

Furthermore, as mentioned hereinbefore, the secure element SEC may be applied to electronic systems of the automobile industry. In this case, the other personalized functions FP are generated by a user coming from the automobile industry, for example for introducing a data certification system of their choice, or implementing a pre-established security function FS but adapted in an optimal manner to their electronic system, or else allowing secure updates in a different way than what is provided by a given standard.

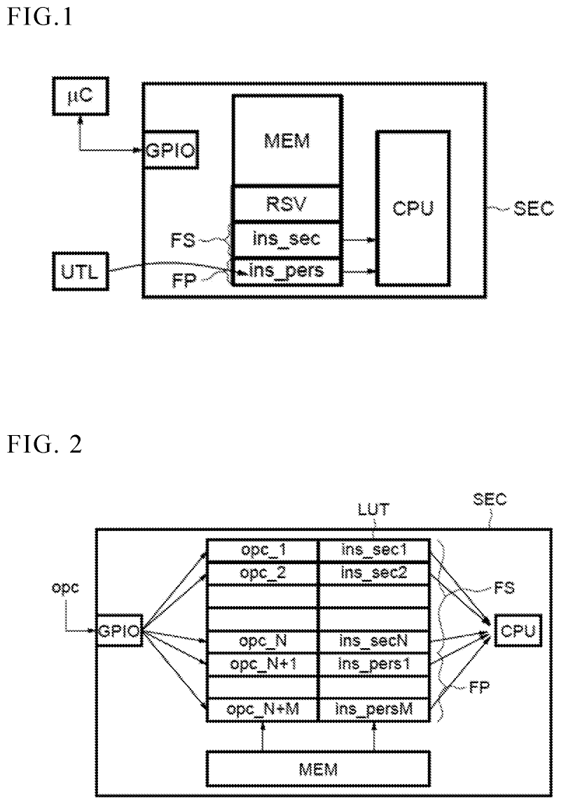

FIG. 2 illustrates one exemplary embodiment of the secure element SEC allowing a quick execution with limited resources. This may correspond to constraints relating to the electronic systems of the automobile industry.

The secure element SEC according to this example comprises a conversion table LUT (usually referred to as a “look-up table”).

The look-up table LUT is configured for converting, on the fly, a received operational code opc into a corresponding instruction from amongst the first instructions ins_sec1, ins_sec2, . . . , ins_secN, and from amongst the second instructions ins_pers1, . . . , ins_persM.

The operational code is, for example, received on the input/output interface GPIO.

Just after the conversion, the processing unit CPU then executes the instruction corresponding to the received operational code.

The term “converting on the fly” as used herein is understood to mean and be limited to a dynamic translation of the received operational code opc into executable machine language (here, the first and second instructions). In other words, the translation is not done during a compilation upstream of the receipt of the operational code opc, but at the time when it is received, and advantageously with no delay.

The look-up table LUT is initialized at each start-up, or power on reset of the secure element SEC.

The initialization of the look-up table LUT comprises, on the one hand, loading from the non-volatile memory MEM of the first instructions ins_sec1-ins_sec_N and second instructions ins_pers1-ins_persM and, on the other hand, but simultaneously, assigning to the first and second instructions ins_sec1-ins_secN, ins_pers1-ins_persM, a respective reference operational code opc_1-opc_N and opc_N+1-opc_M.

In the following, a first instruction will be denoted by ins_sec, a second instruction by ins_pers, and a reference operational code by opc_j.

Thus, the conversion on the fly may comprise a comparison of the operational code received opc with the reference operational codes opc_j so as to identify the corresponding instruction to be executed.

The operational codes opc_j respectively assigned to the first and second instructions ins_sec, ins_pers, are initially contained in the non-volatile memory MEM.

For example, the operational code opc_j is written as a data value into the memory MEM during the loading of the first and second instructions ins_sec, ins_pers.

According to one advantageous alternative, memory locations in the memory MEM are initially associated with respective operational codes opc_j, and the address of the memory location of an instruction ins_sec, inspers allows the respective operational code opc_j to be re-transcribed.

This alternative also allows the loading from the non-volatile memory MEM of the first and second instructions to be optimized. This is because, since the operational codes opc_j are associated with memory locations of the memory MEM, the look-up table LUT may comprise pointers, which could be hard-coded, pointing to these memory locations, allowing the look-up table LUT to be immediately loaded with the instructions thus automatically assigned from the corresponding operational code opc_j.

The look-up table LUT may further comprise locations left empty, for example in order to allow introductions of new pre-established functions in case of future development of a standard, without having to necessarily modify the technology implementing it.

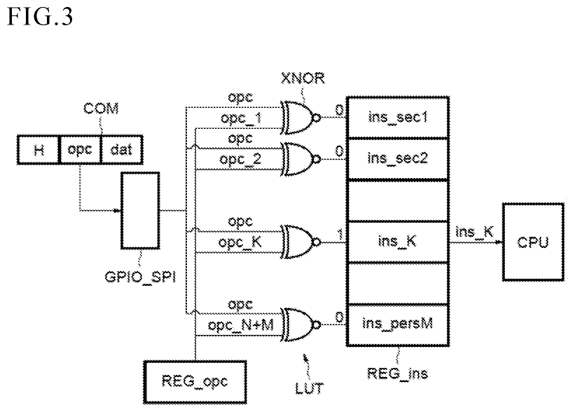

FIG. 3 shows one exemplary embodiment of a look-up table LUT of a secure element SEC of the type of that described in relation with the FIG. 2.

In this example, the look-up table LUT comprises exclusive NOR logic gates XNOR for identifying, on the fly, the received operational code opc with the operational codes opcj_i respectively assigned to the first and second instructions ins_sec, inspers.

The received operational code opc comprises binary data (i.e. “bits”) and comes, for example, from a command COM transmitted according to a communication of the SPI type, received by the input/output interface GPIO_SPI. The command COM according to the SPI protocol contains a header H, an operational code opc, and data dat.

An exclusive NOR logic gate “XNOR” allows a comparison to be made between two input bits, outputting a logical data value “TRUE” (i.e. a “1” bit) if the input bits are equal, and a logical value “FALSE” (i.e. a “0” bit) if the input data are different. An exclusive OR “XOR” gate produces the same effect with the values inverted at the output.

The bits of the received operational code opc are compared one-to-one with the bits of all the operational codes opc_1, opc_2, . . . , opc_k, . . . , opc_N+M of the look-up table LUT, in parallel.

This advantageously allows the reference operational code opc_k, which corresponds to the received operational code opc, to be instantaneously identified (in other words after the time it take to trigger an XNOR gate).

The logical value “TRUE” at the output of the exclusive NOR gate XNOR then allows a command for execution of the instruction ins k, assigned from the identified operational code opc_k, by the processing unit CPU.

For example, a dedicated register REG_opc may contain and supply the bits of the operational codes opc_1-opc_N+M of the look-up table LUT, and another dedicated register REG_ins may contain and supply the instructions ins_sec1-ins_persM of the look-up table LUT.

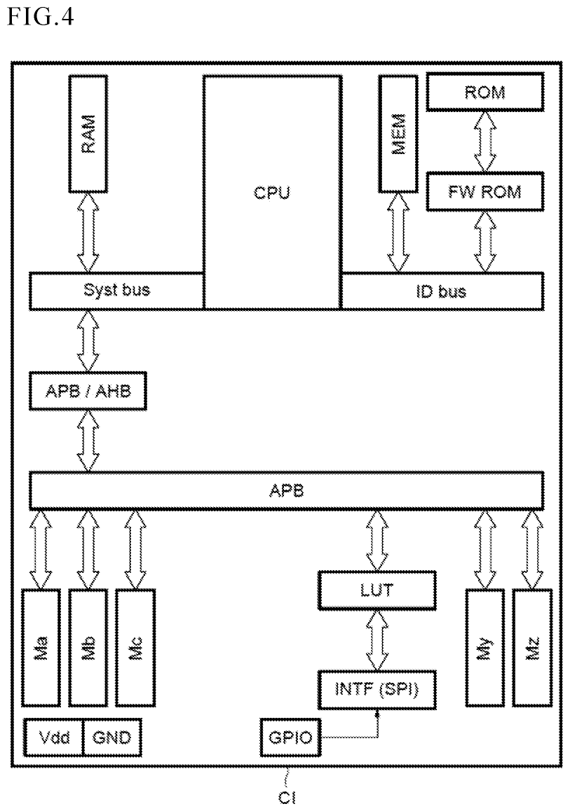

FIG. 4 illustrates one example of an integrated circuit CI incorporating a secure element SEC of the type of one example previously described in relation with FIGS. 1 to 3. Usually, this type of integrated circuit CI is also denoted as “secure element”, and comprises functionalities that are additional to those previously described.

The integrated circuit CI comprises a general purpose input/output interface GPIO, in other words connection elements designed to communicate with peripherals external to the integrated circuit CI, together with conventional power supply voltage Vdd and reference voltage GND application terminals.

The integrated circuit CI comprises a serial peripheral interface INTF capable of decoding information transmitted according to the SPI protocol. An input of the interface INTF is connected to the input/output GPIO, and an output of the interface INTF is connected to the look-up table LUT of the secure element SEC in order to convert, on the fly, a received operational code into a corresponding instruction.

Modules Ma, Mb, Mc, . . . , My, Mz with various functions communicate within the integrated circuit CI via a bus APB, in other words of the “Advanced Peripheral Bus” type.

The modules Ma-Mz may be of the types: clock signal generator, timer, interface for various protocols, random number generator, hardware accelerator for cryptographic calculations, and other types.

A bus bridge APB/AHB allows communications between the bus APB and a first bus system Systbus, for example of the “Advanced High-performance Bus” type.

A volatile memory RAM may communicate over the first bus system Systbus.

A secure processing unit CPU of the integrated circuit CI sends commands in a secure manner to the first bus system Systbus and to a second bus system IDbus. The processing unit CPU previously described in relation with FIGS. 1 to 3 is formed by this secure processing unit CPU of the integrated circuit CI.

The non-volatile memory MEM of the secure element communicates via the second bus system IDbus. For example, the non-volatile memory MEM is of the “Flash” memory type.

A non-volatile read-only memory ROM also communicates over the second bus system IDbus, via a dedicated firewall FWROM.

Thus, in the initialization of the look-up table LUT, during each start-up reset of the integrated circuit, the loading of the first and second instructions from the non-volatile memory MEM is controlled by the secure processing unit CPU to take the following path: second bus system IDbus, the secure processing unit CPU, the first bus system Systbus, the bus bridge AHB/APB, and finally the look-up table LUT via the bus APB.

Once the instructions have been loaded into the look-up table LUT, the corresponding operational codes will be compared, on the fly, with the incoming SPI data stream.

FIG. 5 shows one example of an electronic system of the automobile industry SYS incorporated into a vehicle VHCL of the automobile type.

The system comprises several electronic control units ECU, in particular a telematic control unit TCU, an inter-network gateway unit GTW, a driving assistance unit ADAS.

The telematic control unit TCU comprises global positioning detection and sensor systems GNSS, a modem MDM configured for communicating with a telephone telecommunications network, and a control unit μC of the microcontroller type. The telematic control unit TCU may also comprise a remote updating element (not shown) capable for example of downloading a firmware update from a remote server.

On the other hand, the telematic control unit TCU may also be used to centralize dashboard functions and multimedia (notably audio and video) functions of the vehicle.

The inter-network gateway unit GTW is dedicated to the intercommunication between sub-networks of the automobile electronic system SYS, and comprises a remote updating element OTA, together with a diagnostic element DIAG designed to control a functional state of the elements of the system, and a microcontroller μC.

The driving assistance unit ADAS comprises a microcontroller μC, a control element CMD configured for controlling commands relating to driving assistance, such as the brakes or the steering. The driving assistance unit ADAS furthermore comprises an element for communication TCUTX with the telematic control unit TCU, and an element for communication GTWTX with the inter-network gateway unit GTW.

The telematic control unit TCU, the inter-network gateway unit GTW, the driving assistance unit ADAS, together with secondary electronic control units ECU1-ECU4 communicate via an ethernet router ETH.

The telematic control unit TCU, the inter-network gateway unit GTW, and the driving assistance unit ADAS form units referred to as main units of the system SYS, and all have a critical position with regard to security.

Thus, secure elements SEC such as previously described in relation with FIGS. 1 to 4 are advantageously incorporated into the system SYS. In particular, each main unit TCU, GTW, ADAS comprises a secure element SEC ensuring the authenticity of the actions of the main units.

The secondary units ECU1-ECU4 may also incorporate such secure elements SEC.

The main electronic control units TCU, GTW, ADAS are configured for generating control signals intended to control the executions of the instructions for the secure elements SEC corresponding, according to one example, to master-slave interactions.

For example, a personalized authentication between an external server and the system may be possible via the telematic control unit TCU, by means of personalized functions for this purpose, loaded into the secure element SEC. This type of authentication may allow a downloading of updates for the main units, which may themselves certify the origin of the downloaded program. Furthermore, any type of secure action may be provided within each secure element SEC and personalized in a manner dedicated to a system SYS of this type.

Furthermore, the invention is not limited to these embodiments and their implementations but encompasses all of their variants. For example, although described according to an application to a vehicle electronic system, the secure elements SEC such as described in relation with FIGS. 1 to 4 may be applicable to other electronic systems, for example consumer systems such as computers, telephones, touchscreen tablets, or various connected objects.

1. A method for managing the operation of a secure element, comprising:
loading first instructions into a non-volatile memory of the secure element, wherein said first instructions relate to pre-established security functions;
loading at least one second instruction into the non-volatile memory of the secure element, wherein the at least one second instruction relates to at least one other personalized function; and
executing instructions from the non-volatile memory, wherein said instructions comprise at least one the first instructions and the at least one second instruction.

2. The method according to claim 1, further comprising:
receiving an operational code;
converting the received operational code, on the fly, into a corresponding instruction that is one of the first instructions or is the at least one second instruction; and
executing the corresponding instruction.

3. The method according to claim 2, further comprising:
at each start-up of the secure element, loading from the non-volatile memory the first instructions and the at least one second instruction into a look-up table; and
assigning a respective reference operational code to the first instructions and to the at least one second instruction;
wherein converting comprises comparing the operational code with the reference operational codes so as to identify the corresponding instructions to be executed.

4. The method according to claim 3, wherein the received operational code comprises binary data, and wherein comparing comprises performing an exclusive NOR logical operation for identifying, on the fly, the reference operational code corresponding to the received operational code.

5. The method according to claim 4, further comprising receiving an input control signal on an input/output interface of the secure element, said input control signal comprising the received operational code.

6. The method according to claim 1, wherein loading the first instructions and the at least one second instruction into the non-volatile memory is performed only once during a phase for production of the secure element.

7. The method according to claim 1, wherein the pre-established security functions form part of a library of commands and of functionalities as specified in the standard “TCG-TPM 2.0”.

8. The method according to claim 1, wherein the at least one other personalized function comprises a function which is not provided by the pre-established security functions.

9. The method according to claim 1, wherein the at least one other personalized function comprises a complementary function improving the execution of one of the pre-established security functions.

10. The method according to claim 1, wherein the at least one other personalized function comprises a complementary function personalizing the execution of one of the pre-established security functions.

11. The method according to claim 1, further comprising generating at least one control signal designed to control said executing.

12. The method according to claim 11, wherein generating is performed in a vehicle of the automobile type, and wherein the at least one control signal is generated by an electronic control unit incorporated into the vehicle.

13. The method according to claim 12, wherein the electronic control unit is selected from the group consisting of: a telematic control unit, an inter-network gateway unit, and a driving assistance unit.

14. A secure element, comprising:
a non-volatile memory configured to store first instructions relating to pre-established security functions and store at least one second instruction relating to at least one other personalized function; and
a processing unit configured to execute at least one instruction from amongst the first instructions and the at least one second instruction as received from the non-volatile memory.

15. The secure element according to claim 14, further comprising:
an input configured to receive an operational code; and
a look-up table configured to convert the received operational code, on the fly, into a corresponding instruction belonging to one of the first instructions or the at least one second instruction;
wherein the processing unit is configured to execute the corresponding instruction.

16. The secure element according to claim 15, configured to load the first instructions and the at least one second instruction from the non-volatile memory at each start-up of the secure element and assign to the first instructions and the at least one second instruction respective reference operational codes, and wherein the look-up table is configured to compare the received operational code with the reference operational codes so as to identify the corresponding instructions to be executed.

17. The secure element according to claim 16, wherein the received operational code comprises binary data, and wherein the look-up table comprises an exclusive NOR logic circuit configured to identify, on the fly, the reference operational code corresponding to the received operational code.

18. The secure element according to claim 15, further comprising an input/output interface configured for connection to an electronic control unit, and wherein the input/output interface receives an input control signal comprising the received operational code.

19. The secure element according to claim 14, wherein the non-volatile memory is configured to be written to only once during a phase for production of the secure element.

20. The secure element according to claim 14, wherein the pre-established security functions form part of a library of commands and of functionalities of the standard “TCG-TPM 2.0”.

21. The secure element according to claim 14, wherein the at least one other personalized function comprises a function which is not provided by the pre-established security functions.

22. The secure element according to claim 14, wherein the at least one other personalized function comprises a complementary function for improving execution of one of the pre-established security functions.

23. The secure element according to claim 14, wherein the at least one other personalized function comprises a complementary function for personalizing the execution of one of the pre-established security functions.

24. A system, comprising:
a secure element according to claim 14; and
at least one electronic control unit configured to generate control signals designed to control the execution of the at least one instruction.

25. A vehicle of the automobile type, comprising:
a system according to claim 24,
wherein the at least one electronic control unit comprises at least one of: a telematic control unit, an inter-network gateway unit, and a driving assistance unit.
